(19) United States
(12) Patent Application Publication
(10) Pub. No.: US 2017/0149571 A1
(43) Pub. Date: May 25, 2017

(54) Method, Apparatus and System for Handshaking Between Client and Server

(71) Applicants: Le Holdings (Beijing) Co., Ltd., Beijing (CN); LeCloud Computing Co., Ltd., Beijing (CN)

(72) Inventor: Guoliang SUN, Beijing (CN)

(21) Appl. No.: 15/245,371

(22) Filed: Aug. 24, 2016

Related U.S. Application Data
(63) Continuation of application No. PCT/CN2016/082818, filed on May 20, 2016.

(30) Foreign Application Priority Data
Nov. 19, 2015 (CN) 201510802482.7

(51) Int. Cl. H04L 9/32; H04L 29/06; H04L 9/08; H04L 29/08

(52) U.S. Cl. CPC H04L 9/3268; H04L 67/2842; H04L 63/0823; H04L 63/0442; H04L 9/0825; H04L 9/0869; H04L 63/168; H04L 2209/24

(57) ABSTRACT

Disclosed are a method, an apparatuses and a system for handshaking between a client and a server. The method includes: sending handshaking request information by the client to a source server through a cache server; encrypting, by the source server, certificate information with a private key managed by the source server; sending, to the cache server, the encrypted certificate information configured to be forwarded to the client; verifying the certificate information by the client; sending, to the cache server, key generation information configured to be forwarded to the source server; and decrypting the key generation information by the source server through the private key to obtain a symmetric key.

### CROSS-REFERENCE TO RELATED APPLICATIONS

This application is a continuation of International Application No. PCT/CN2016/082818, filed on May 20, 2016, which is based upon and claims priority to Chinese Patent Application No. 201510802482.7, filed on Nov. 19, 2015, the entire contents of both the applications are incorporated herein by reference.

### TECHNICAL FIELD

On one aspect, the present disclosure relates to the field of internet technologies, and particularly, to a method, an apparatus and a system for handshaking between at least one client and at least one server.

### BACKGROUND

Generally, Hypertext Transfer Protocol (abbreviated as HTTP) technology is used for communicating between a client and a server. HTTP is characterized by performing data transfer in clear text. To an E-bank system of a bank or a payment system of an electronic merchant, information such as an account number and a password or the like involves financial security of a user, and thus it is not suitable to transfer in clear text.

In order to improve security of data transfer, at present, there is a new transfer protocol which is called Hypertext Transfer Protocol Secure (abbreviated as HTTPS). Base on HTTPS, all transferred data between the client and the server are encrypted, and third parties are unable to decrypt the encrypted data without obtaining a corresponding encryption key. Data encryption is required between a client side and a server side by using a corresponding encryption key. Therefore, before communicating based on HTTPS, it is first required for handshaking between the client and the server, then the client and the server obtain the encryption key through certificate authentication, key negotiation and other procedures. In practical application, a handshaking process involves with two sets of keys: one is an asymmetric key, and the other is a symmetric key. All information (for example, certificate information, the symmetric key and so on) transferred in the process of handshaking between the client and the server is encrypted by using the asymmetric key. The server has a private key of its own for encrypting sent information or decrypting received information; and the client has a public key corresponding to the private key for decrypting information encrypted by the server by means of the private key or encrypting sent information so that the server decrypts the encrypted information with the private key. The symmetric key is an encryption key obtained by means of negotiation in the process of handshaking between the client and the server, and is used for encrypting or decrypting subsequently transferred HTTPS data.

Content Distribution Network (CDN) is a new-type network architecture which is different with a traditional network and characterized in that one or more cache servers are additionally provided between the client and the server. After the one or more cache servers have been additionally provided, the original server is referred as a source server. When HTTPS is used in CDN, in the prior art, generally the source server is replaced by the cache server for handshaking with the client, namely, certificate authentication and key negotiation are carried out between the cache server and the client. Therefore, the private key of the source server needs to be deployed in the cache server. Generally, the source server is affiliated with a content provider, and the cache server is managed by a content distributor. A greater security risk exists if a private key of a site of the content provider is open to a third party for use. Immeasurable losses will be caused to the content provider once a third-party server is hacked and thus causing disclosure of the private key of the site.

### SUMMARY

The present disclosure provides a method, an apparatus and a system for handshaking between a client and a server, which can solve a problem of low security in deployment of a private key.

In order to solve the foregoing problem, in a first aspect, some embodiments of the present disclosure provide a method for handshaking between a client and a server, implemented by a cache server, and the method includes:

forwarding handshaking request information sent by the client to a source server, wherein the handshaking request information is configured to request to establish a handshaking process with the source server;

forwarding, to the client, certificate information sent by the source server, wherein the certificate information is encrypted with a private key by the source server; and

after the client verifies the certificate information, forwarding, to the source server, key generation information sent by the client so that the source server obtains a symmetric key by decrypting the key generation information with the private key.

In a second aspect, some embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for handshaking between a client and a server mentioned by embodiments of the present disclosure.

In a third aspect, some embodiments of the present disclosure provide an electronic device, including:

at least one processor; and

a memory communicably connected with the at least one processor for storing instructions executable by the at least one processor, wherein execution of the instructions by the at least one processor causes the at least one processor to:

receive, through a cache server, handshaking request information sent by the client, wherein the handshaking request information is configured to request to establish a handshaking process with the electronic device;

encrypt certificate information with a private key managed by the electronic device;

send, to the cache server, the encrypted certificate information configured to be forwarded to the client so that the client verifies the certificate information;

receive key generation information sent by the client through the cache server; and

decrypt the key generation information with the private key and obtain a symmetric key.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for handshaking between a client and a server in accordance with some embodiments;

FIG. 2 is a flowchart of another method for handshaking between a client and a server in accordance with some embodiments;

FIG. 3 is a flowchart of still another method for handshaking between a client and a server in accordance with some embodiments;

FIG. 4 is a flowchart of still another method for handshaking between a client and a server in accordance with some embodiments;

FIG. 5 is a block diagram of composition of an apparatus for handshaking between a client and a server in accordance with some embodiments;

FIG. 6 is a block diagram of composition of another apparatus for handshaking between a client and a server in accordance with some embodiments;

FIG. 7 is a block diagram of composition of still another apparatus for handshaking between a client and a server in accordance with some embodiments;

FIG. 8 is a block diagram of composition of still another apparatus for handshaking between a client and a server in accordance with some embodiments;

FIG. 9 is a schematic diagram of a system for handshaking between a client and a server in accordance with some embodiments; and

FIG. 10 is a block diagram of an electronic device in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are some but not all of the embodiments of the present disclosure.

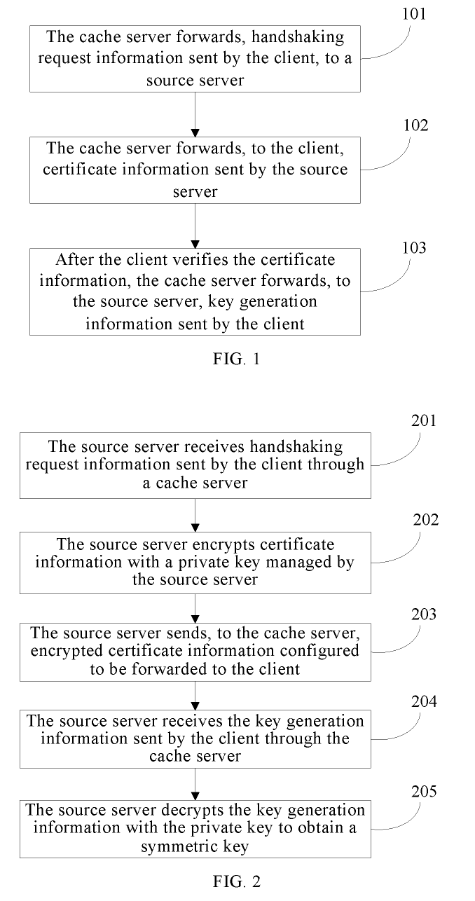

An embodiment of the present disclosure provides a method for handshaking between a client and a server, and the method is applied to a cache server. As shown in FIG. 1, the method includes:

101: The cache server forwards, handshaking request information sent by the client, to a source server.

The handshaking request information is sent out by the client and used for requesting to establish a handshaking process with the source server. In CDN, all information interactions between the client and the source server are forwarded through the cache server. In this step, the handshaking request information sent by the client to the source server is sent to the cache server.

After receiving the handshaking request information, the cache server forwards the information to a corresponding source server. The so-called corresponding source server refers to the source server with which the client requests to establish a handshaking connection.

According to an existing Secure Sockets Layer (SSL) Protocol, before establishing an HTTPS connection, the client or the server sending arbitrary information to the other party for signifying a request of handshake with the other party. Therefore, the handshaking request information in this embodiment may carry arbitrary data, and this embodiment does not limit contents of the handshaking request information. In one implementation of this embodiment, the handshaking request information sent by the client can be “Hello”.

In this step, it is unnecessary for the client to encrypt the handshaking request information. The reason is: the handshaking request information is merely used for expressing an intention of handshaking with an opposite end, neither having actual meaning nor involving sensitive information. Therefore, it is unnecessary for the client to encrypt the handshaking request information.

102: The cache server forwards, to the client, certificate information sent by the source server.

After receiving the handshaking request information, the source server returns the certificate information to the client, wherein the certificate information comprises a digital certificate applied for registration by the source server in a third-party certificate management department. The cache server forwards the certificate information sent by the source server to the client so that the client verifies reliability of the source server according to the certificate information.

In this embodiment, by means of a private key which is saved and managed by itself, the source server encrypts the certificate information, and the client decrypts the received certificate information by using a public key corresponding to the private key. The public key of the source server is saved in a third-party site, and any devices in the network can request to acquire the public key from the third-party site. The client can request a corresponding public key from the third-party site according to a domain name of the source server, or receive the public key sent together with the certificate information. To the latter manner, the source server needs to send its own public key together with the certificate information to the client.

103: After the client verifies the certificate information, the cache server forwards, to the source server, key generation information sent by the client.

The client decrypts the certificate information by means of the public key of the source server and checks whether the domain name recorded therein is consistent with a domain name requested by the client or not. If the two domain names are consistent, this means that the domain name requested by the client is the real domain name of the source server therefore the client will trust the source server, and verification of the certificate information is finished. If the two domain names are inconsistent, the client distrusts the source server, the subsequent steps in FIG. 1 are terminated, and the handshaking connection is failed.

After the verification is passed, the client sends the key generation information to the cache server which forwards the information to the source server. By using the key generation information, the source server obtains an encryption key used in the process of subsequent communication with the client, wherein the encryption key is another key different from the forgoing private key and the public key. In a communication process, the client and the source server use the same encryption key to encrypt HTTPS data. Therefore, this encryption key is also referred to symmetric key.

In this step, the client may generate this symmetric key by itself, or send the generated symmetric key to the source server in the form of key generation information. In addition, the client can also send necessary information (for example, a random data) for generating the symmetric key to the source server by means of key generation information, and the source server generates the symmetric key by itself according to the necessary information.

In this embodiment, the client can use the public key of the source server to encrypt the key generation information. After receiving the key generation information, the source server decrypts the key generation information by means of the private key which is saved and managed by itself to obtain the symmetric key.

At this point, the handshaking process between the client and the source server is finished, the HTTPS connection is established, and thereafter the client and the source server can use the symmetric key to encrypt or decrypt transferred HTTPS information.

In this embodiment, the private key of the source server is saved and managed by the source server itself, and the source server participates in the handshaking process between the client and the source server. The cache server of the third party merely plays a role of data forwarding and transferring handshaking information of interaction between the client and the source server in the handshaking process. Since the cache server does not need to know specific contents in the handshaking information, it is unnecessary to use the private key of the source server to decrypt the handshaking information. Therefore, the private key of the source server may be not open to the cache server, thereby security in deployment of the private key is improved.

An embodiment of the present disclosure further provides a method for handshaking between a client and a server, and the method is applied to a source server. As shown in FIG. 2, the method includes:

201: The source server receives handshaking request information sent by the client through a cache server.

The handshaking request information sent by the client is forwarded to the source server by the cache server, and the handshaking request information is identical to the handshaking request information in Step 101 in FIG. 1.

202: The source server encrypts certificate information with a private key managed by the source server itself.

After receiving the handshaking request information, the source server acquires the certificate information of its own and encrypts the certificate information with the private key.

In this embodiment, the private key of the source server is saved in the source server locally and is not open to the cache server. Therefore, it is required that the source server uses the private key to encrypt the certificate information.

203: The source server sends, to the cache server, encrypted certificate information configured to be forwarded to the client.

The source server sends the encrypted certificate information to the cache server which forwards the certificate information to the client for verification.

As previously mentioned, the client can acquire a public key corresponding to the private key by means of a third-party site or the source server. The client uses the corresponding public key to decrypt the encrypted certificate information, and then verifies the certificate information. When the verification is passed, the client generates key generation information, and sends, to the cache server, the key generation information configured to be forwarded to the source server. However, when the verification is failed, subsequent steps will not be executed, and the handshaking process will be terminated.

In this embodiment, the client uses the public key of the source server to encrypt the key generation information, and then sends the encrypted key generation information to the cache server for forwarding.

204: The source server receives the key generation information sent by the client through the cache server.

205: The source server decrypts the key generation information with the private key to obtain a symmetric key.

Since the key generation information is encrypted by means of the public key corresponding to the private key, the key generation information can be decrypted by means of the private key. After the source server decrypts the key generation information with the private key, the symmetric key is obtained.

In this embodiment, the key generation information may directly carry the symmetric key generated by the client, or merely carry necessary information (for example, a random data) for generating the encryption key. The source server generates by itself a symmetric key identical to the symmetric key at the client side according to the random data.

At this point, the handshaking process between the client and the source server is finished, the HTTPS connection is established, and thereafter the client and the source server can use the symmetric key to encrypt or decrypt transferred HTTPS information.

In this embodiment, the private key of the source server is saved and managed by the source server itself, and the source server participates in the handshaking process between the client and the source server. The cache server of the third party merely plays a role of data forwarding and transferring handshaking information of interaction between the client and the source server in the handshaking process. Since the cache server does not need to know specific contents in the handshaking information, it is unnecessary to use the private key of the source server to decrypt the handshaking information. Therefore, the private key of the source server may be not open to the cache server, thereby security in deployment of the private key is improved.

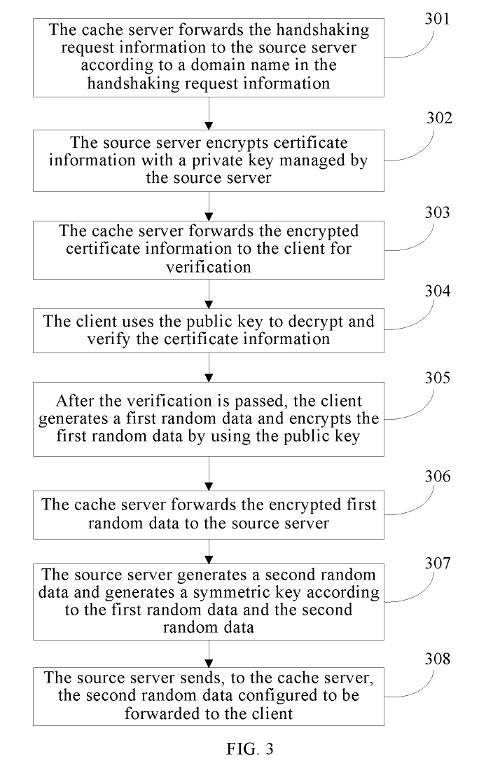

Further, as refinement of the method as shown in FIG. 1 and FIG. 2, an embodiment of the present disclosure further provides a method for handshaking between a client and a server, and the method relies on a client, a cache server and a source server for implementation. As shown in FIG. 3, the method includes:

301: The cache server forwards the handshaking request information to the source server according to a domain name in the handshaking request information.

When the client reports the handshaking request information to the cache server, the client sends the handshaking request information together with the domain name of the source server to the cache server. The domain name is sent by the cache server to a domain name system (DNS) server for resolution, therefore an Internet Protocol (IP) address of the source server is obtained, and then the IP address is used as a destination IP address and the handshaking request information is sent to the source server.

302: The source server encrypts certificate information with a private key managed by the source server itself.

The certificate information can include following specific contents: information of a third-party electronic certificate authority, user information of the public key, signature of an authority and validity of the certificate, wherein the user information of the public key specifically can be domain name information of the source server. In this embodiment, a format of the certificate and a verification method thereof can follow X.509 International Standard.

In this embodiment, there are two objectives to encrypt the certificate information: a first objective is to prevent a third party from illegally intercepting and tampering with the certificate information, particularly tampering with the domain name of the source server, which may directly result in failure of verification of the client and termination of the handshaking process. A second objective is to indirectly verify whether the public key used at the client side matches with the private key used at the source server. In an asymmetric encryption algorithm, data encryption or decryption can be mutually carried out between a pair of matched public key and private key, namely, data encrypted through the private key can be decrypted by using the public key, and data encrypted through the public key can also be decrypted with the private key. However, a precondition of mutual encryption or decryption is that the public key and the private key are matched. Successful decryption between the public key and the private key is impossible if they are not matched. If the public key used at the client can decrypt the certificate information encrypted by the source server with the private key, it can be determined that the public key used at the client matches with the private key used at the source server.

303: The cache server forwards the encrypted certificate information to the client for verification.

According to an existing protocol, after the server is located by the client as a handshaking object through the domain name, a handshaking connection is established between the client and the server, and the server can directly return data to the client initiating a handshaking request through the connection, without looking up the client. In this step, the source server can directly send, to the cache server, the certificate information configured to be forwarded to the client initiating a handshaking request.

304: The client uses the public key to decrypt and verify the certificate information.

The client uses the public key to decrypt the certificate information, acquires therefrom information of a domain name authenticated by a third-party certification authority, and then compares the domain name with a domain name requested by the client itself. The verification is passed when the two domain names are consistent.

305: After the verification is passed, the client generates a first random data and encrypts the first random data by using the public key.

In practical application, the client can use a pseudorandom data generator to generate the first random data.

In this embodiment, the client provides necessary information for generating the symmetric key for the source server, namely, the first random data generated in Step 305 is provided.

306: The cache server forwards the encrypted first random data to the source server.

307: The source server generates a second random data and generates a symmetric key according to the first random data and the second random data.

The source server decrypts the received first random data with the private key, generates a second random data, and then generates a symmetric key on a basis of the first random data and the second random data. In practical application, the source server can use a pseudorandom data generator to generate the second random data.

308: The source server sends, to the cache server, the second random data configured to be forwarded to the client.

The source server encrypts the generated second random data by means of the private key and sends, to the cache server, the second random data configured to be forwarded to the client. The client decrypts the encrypted second random data by using the public key, and then generates an identical symmetric key by using a preset algorithm identical to the preset algorithm at the source server side in combination with the first random data generated by the client itself. Thus, the client side and the source server side respectively obtain the symmetric key generated according to the first random data and the second random data. The symmetric key generated at the client side and the source server side is identical because bases of generating the symmetric key at the both sides are the first random data and the second random data and the same preset algorithm is used.

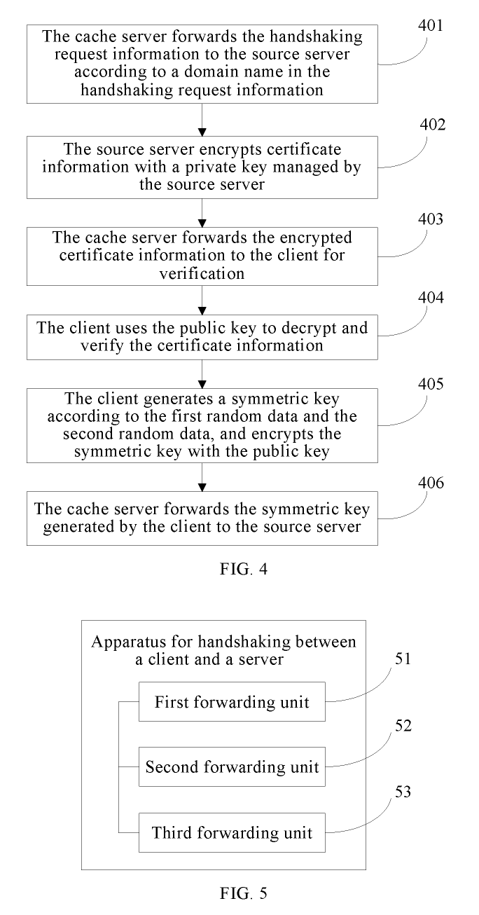

Further, as refinement of the method shown in FIG. 1 and FIG. 2, an embodiment of the present disclosure further provides a method for handshaking between a client and a server, and the method relies on a client, a cache server and a source server for implementation. As shown in FIG. 4, the method includes:

401: The cache server forwards the handshaking request information to the source server according to a domain name in the handshaking request information.

An implementation mode of this step is the same as that of Step 301 in FIG. 3, and thus is not unnecessarily described herein.

402: The source server encrypts certificate information with a private key managed by the source server itself.

In this embodiment, the symmetric key is generated by the client according to the first random data and the second random data, and then is sent to the source server for use. Therefore, in this step, the source server needs to generate a second random data and add the second random data into the certificate information which is sent to the client.

403: The cache server forwards the encrypted certificate information to the client for verification.

404: The client uses the public key to decrypt and verify the certificate information.

405: the client generates a symmetric key according to the first random data and the second random data, and encrypts the symmetric key through the public key.

The client uses a pseudorandom data generator to generate a first random data, then generates a symmetric key through a preset algorithm in combination with the second random data in the certificate information, and sends the symmetric key to the source server for use.

406: The cache server forwards the symmetric key generated by the client to the source server.

The source server obtains the symmetric key through decryption with the private key, thereby the handshaking process is finished, so that both the client side and the source server side obtain the same symmetric key.

Further, as implementation of the foregoing method, an embodiment of the present disclosure further provides an apparatus for handshaking between a client and a server. The apparatus is positioned in a cache server, or is independent of the cache server but a data interaction is established between the apparatus and the cache server, so as to implement the foregoing method. As shown in FIG. 5, the apparatus includes:

a first forwarding unit 51, configured to forward, to a source server, handshaking request information sent by the client, wherein the handshaking request information is configured to request to establish a handshaking process with the source server.

The handshaking request information is sent out by the client and is used for requesting to establish a handshaking process with the source server. In CDN, all information interactions between the client and the source server are forwarded through the cache server. The handshaking request information sent by the client to the source server is sent to the cache server. After receiving the handshaking request information, the cache server forwards the information to a corresponding source server. The so-called corresponding source server refers to the source server with which the client requests to establish a handshaking connection.

A second forwarding unit 52, configured to forward, to the client, certificate information sent by the source server, wherein the certificate information is encrypted with a private key by the source server.

After receiving the handshaking request information, the source server returns the certificate information to the client, wherein the certificate information comprises a digital certificate applied for registration by the source server in a third-party certificate management department. The cache server forwards the certificate information sent by the source server to the client so that the client verifies reliability of the source server according to the certificate information.

In this embodiment, by means of the private key which is saved and managed by itself, the source server encrypts the certificate information, and the client decrypts the received certificate information by using a public key corresponding to the private key. The public key of the source server is saved in a third-party site, and any devices in the network can request to acquire the public key from the third-party site. The client can request a corresponding public key from the third-party site according to a domain name of the source server, or receive the public key sent together with the certificate information. To the latter manner, the source server needs to send its own public key together with the certificate information to the client.

A third forwarding unit 53, configured to forward, after the client verifies the certificate information, to the source server, key generation information sent by the client so that the source server obtains a symmetric key according to the decrypted private key.

The client decrypts the certificate information by means of the public key of the source server and checks whether the domain name recorded therein is consistent with a domain name requested by the client. If the two domain names are consistent, this means that the domain name requested by the client is the real domain name of the source server, then the client trusts the source server, and verification of the certificate information is finished. If the two domain names are inconsistent, then the client distrusts the source server, and the handshaking connection is failed.

After the verification is passed, the client sends the key generation information to the cache server which forwards the information to the source server. By using the key generation information, the source server obtains an encryption key used in the process of subsequent communication with the client, wherein the encryption key is another key different from the forgoing private key and the public key. In a communication process, the client and the source server use the same encryption key to encrypt HTTPS data. Therefore, this encryption key is also referred to symmetric key.

The client can generate this symmetric key by itself, and send the generated symmetric key to the source server in the form of key generation information. In addition, the client can also send necessary information (for example, a random data) for generating the symmetric key to the source server by means of key generation information, and the source server generates the symmetric key by itself according to the necessary information.

In this embodiment, the client can use the public key of the source server to encrypt the key generation information. After receiving the key generation information, the source server decrypts the key generation information by means of the private key which is saved and managed by itself to obtain the symmetric key.

Further, the first forwarding unit 51 is configured to forward the handshaking request information to the source server according to a domain name in the handshaking request information.

When the client reports the handshaking request information to the cache server, the client sends the handshaking request information together with the domain name of the source server to the cache server. The domain name is sent by the cache server to a DNS server for resolution, an IP address of the source server is obtained, and then the IP address is used as a destination IP address and the handshaking request information is sent to the source server.

Further, the third forwarding unit 53 is configured to forward a first random data generated by the client to the source server so that the source server generates the symmetric key according to the first random data and a second random data generated by the source server itself.

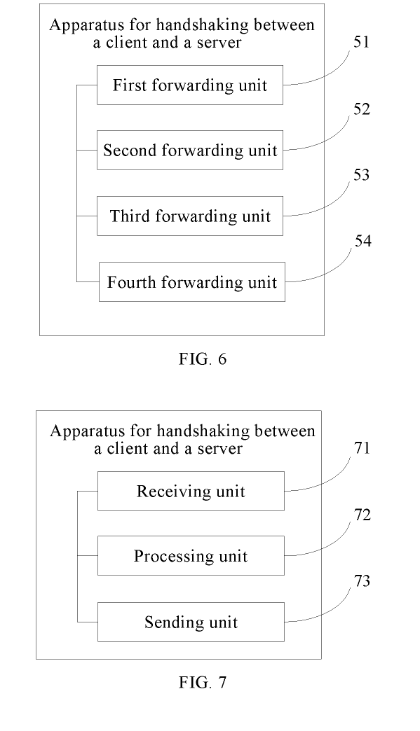

Further, as shown in FIG. 6, the apparatus further includes:

a fourth forwarding unit 54, configured to forward the second random data generated by the source server to the client so that the client generates a symmetric key identical to the symmetric key generated by the source server according to the first random data and the second random data.

In practical application, the client can use a pseudorandom data generator to generate the first random data. The source server decrypts the received first random data with the private key, generates a second random data, and then generates a symmetric key on a basis of the first random data and the second random data. In practical application, the source server can use a pseudorandom data generator to generate the second random data.

The source server encrypts the generated second random data by means of the private key and sends, to the cache server, the second random data configured to be forwarded to the client. The client decrypts the encrypted second random data by using the public key, and then generates an identical symmetric key by using an identical preset algorithm at the source server side in combination with the first random data generated by the client itself. Thus, the client side and the source server side respectively obtain the symmetric key generated according to the first random data and the second random data. The symmetric key generated at the client side and the source server side is identical because bases of generating the symmetric key at the both sides are the first random data and the second random data and the same preset algorithm is used.

Further, the certificate information forwarded by the second forwarding unit 52 carries the second random data generated by the source server; and

the third forwarding unit 53 is configured to forward the symmetric key generated by the client to the source server, wherein the symmetric key is the symmetric key generated by the client according to the first random data generated by the client itself and the received second random data.

In this embodiment, the symmetric key is generated by the client according to the first random data and the second random data, and then is sent to the source server for use. Therefore, the source server needs to generate a second random data and add the second random data into the certificate information which is sent to the client. The client uses a pseudorandom data generator to generate a first random data, then generates a symmetric key through a preset algorithm in combination with the second random data in the certificate information, and sends the symmetric key to the source server for use. The source server obtains the symmetric key through decryption with the private key, thereby finishing the handshaking process, so that both the client side and the source server side obtain the same symmetric key.

Further, as implementation of the foregoing method, an embodiment of the present disclosure further provides an apparatus for handshaking between a client and a server. The apparatus is positioned in a source server, or is independent of the source server but a data interaction is established between the apparatus and the source server, so as to implement the foregoing method. As shown in FIG. 7, the apparatus includes: a receiving unit 71, a processing unit 72 and a sending unit 73.

The receiving unit 71 is configured to receive handshaking request information sent by the client through a cache server, wherein the handshaking request information is configured to request to establish a handshaking process with the source server.

The processing unit 72 is configured to encrypt certificate information with a private key managed by the processing unit itself.

In this embodiment, the private key of the source server is saved in the source server locally and is not open to the cache server. Therefore, it is required that the source server uses the private key to encrypt the certificate information.

The sending unit 73 is configured to send, to the cache server, the encrypted certificate information configured to be forwarded to the client so that the client verifies the certificate information.

As previously mentioned, the client may acquire a public key corresponding to the private key by means of a third-party site or the source server. The client uses the corresponding public key to decrypt the encrypted certificate information, and then verifies the certificate information. When the verification is passed, the client generates key generation information, and sends, to the cache server, the key generation information configured to be forwarded to the source server. However, when the verification is failed, the handshaking process is terminated.

In this embodiment, the client uses the public key of the source server to encrypt the key generation information, and then sends the encrypted key generation information to the cache server for forwarding.

The source server sends the encrypted certificate information to the cache server which forwards the certificate information to the client for verification.

The receiving unit 71 is further configured to receive key generation information sent by the client through the cache server; and

the processing unit 72 is further configured to decrypt the key generation information with the private key to obtain a symmetric key.

Since the key generation information is encrypted by means of the public key corresponding to the private key, the key generation information may be decrypted by means of the private key. After the source server decrypts the key generation information with the private key, the symmetric key is obtained.

In this embodiment, the key generation information can directly carry the symmetric key generated by the client, or merely carry necessary information (for example, a random data) for generating the encryption key. The source server generates by itself a symmetric key identical to the symmetric key at the client side according to the random data.

Further, the key generation information received by the receiving unit 71 is a first random data generated by the client.

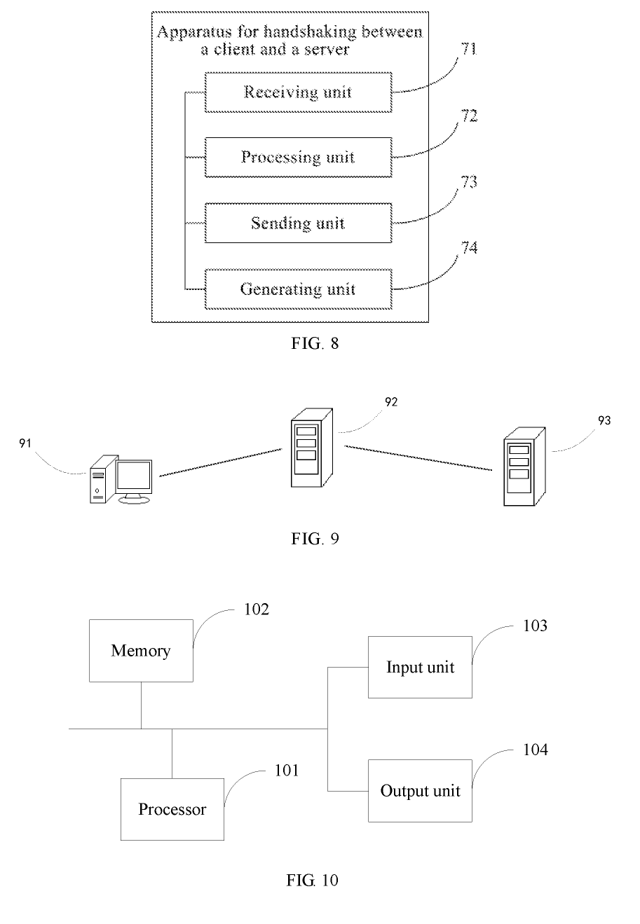

As shown in FIG. 8, the apparatus further includes:

a generating unit 74, configured to generate a symmetric key according to the first random data and a second random data generated by the generating unit itself; and

the sending unit 73, configured to send, to the cache server, the second random data configured to be forwarded to the client after obtaining the symmetric key so that the client generates an identical symmetric key according to the first random data and the second random data.

In practical application, the client may use a pseudorandom data generator to generate the first random data. The source server decrypts the received first random data with the private key, generates a second random data, and then generates a symmetric key on a basis of the first random data and the second random data. In practical application, the source server can use a pseudorandom data generator to generate the second random data.

The source server encrypts the generated second random data by means of the private key and sends, to the cache server, the second random data configured to be forwarded to the client. The client decrypts the encrypted second random data by using the public key, and then generates an identical symmetric key by using an identical preset algorithm at the source server side in combination with the first random data generated by the client itself. Thus, the client side and the source server side respectively obtain the symmetric key generated according to the first random data and the second random data. The symmetric key generated at the client side and the source server side is identical because bases of generating the symmetric key at the two sides are the first random data and the second random data and the same preset algorithm is used.

Further, the certificate information sent by the sending unit 73 carries the second random data generated by the source server; and

the receiving unit 71 is configured to receive a symmetric key sent by the client through the cache server, wherein the symmetric key is the symmetric key generated by the client according to the first random data generated by the client itself and the second random data in the certificate information.

In this embodiment, the symmetric key is generated by the client according to the first random data and the second random data, and then is sent to the source server for use. Therefore, the source server needs to generate a second random data and add the second random data into the certificate information which is sent to the client. The client uses a pseudorandom data generator to generate a first random data, then generates a symmetric key through a preset algorithm in combination with the second random data in the certificate information, and sends the symmetric key to the source server for use. The source server obtains the symmetric key through decryption with the private key, thereby the handshaking process is finished, so that both the client side and the source server side obtain the same symmetric key.

Further, as implementation of the foregoing method, an embodiment of the present disclosure further provides a system for handshaking between a client and a server. As shown in FIG. 9, the system includes a client 91, a cache server 92 and a source server 93. The cache server 92 includes the apparatus as shown in FIG. 5 or FIG. 6, or is independent of the apparatus but has a data interaction with the apparatus; and the source server 93 includes the apparatus as shown in FIG. 7 or FIG. 8, or is independent of the apparatus but has a data interaction with the apparatus

The client 91 is configured to send, to the cache server 92, handshaking request information configured to be forwarded to the source server 93, wherein the handshaking request information is configured to request to establish a handshaking process with the source server 93.

The handshaking request information is sent out by the client 91 and is used for requesting to establish a handshaking process with the source server 93. In CDN, all information interactions between the client 91 and the source server 93 are forwarded through the cache server 92. The handshaking request information sent by the client 91 to the source server 93 is sent to the cache server 92. After receiving the handshaking request information, the cache server 92 forwards the information to a corresponding source server 93. The so-called corresponding source server 93 refers to the source server 93 with which the client 91 requests to establish a handshaking connection.

The source server 93 is configured to encrypt certificate information with a private key managed by the source server itself and send, to the cache server 92, the encrypted certificate information configured to be forwarded to the client 91.

After receiving the handshaking request information, the source server 93 returns the certificate information to the client 91, wherein the certificate information comprises a digital certificate applied for registration by the source server 93 in a third-party certificate management department. The cache server 92 forwards the certificate information sent by the source server 93 to the client 91 so that the client 91 verifies reliability of the source server 93 according to the certificate information.

The client 91 is further configured to verify the certificate information and send, to the cache server 92, key generation information configured to be forwarded to the source server 93; and

the source server 93 is further configured to decrypt the key generation information by means of the private key to obtain the symmetric key.

The client 91 decrypts the certificate information by means of the public key of the source server 93 and checks whether the domain name recorded therein is consistent with a domain name requested by the client 91 or not. If the two domain names are consistent, this means that the domain name requested by the client 91 is the real domain name of the source server 93, the client 91 trusts the source server 93, and verification of the certificate information is finished. If the two domain names are inconsistent, the client 91 distrusts the source server 93, and the handshaking connection is failed.

After the verification is passed, the client 91 sends the key generation information to the cache server 92 which forwards the information to the source server 93. By using the key generation information, the source server 93 obtains an encryption key used in the process of subsequent communication with the client 91, wherein the encryption key is another key different from the forgoing private key and the public key. In a communication process, the client 91 and the source server 93 use the same encryption key to encrypt HTTPS data. Therefore, this encryption key is also referred to as a symmetric key.

The apparatus and system for handshaking between a client and a server provided by this embodiment can directly implement handshaking between the source server and the client, and the cache server is merely used for proxy forwarding handshaking information of interaction between the source server and the client. It is unnecessary for the cache server to use the private key of the source server because forwarding does not involve with information encryption or decryption. Compared with handshaking between a cache server and a client in the prior art, in this embodiment, the private key of the source server is unnecessary to be open to the cache server. Therefore, a hidden danger of disclosure of the private key of the site by the third party may be eliminated, thereby improving security in deployment of the private key.

Further, an embodiment of the present disclosure further provides a non-transitory computer-readable storage medium storing executable instructions, which can be executed by an electronic device to perform any methods for handshaking between a client and a server mentioned by embodiments of the present disclosure.

FIG. 10 is a block diagram of an electronic device which is configured to perform the methods for handshaking between a client and a server according to an embodiment of the present disclosure. As shown in FIG. 10, the device includes: one or more processors 101 and memory 102. A processor 101 is showed in FIG. 10 for an example.

Device which is configured to perform the methods for handshaking between a client and a server can also include: input unit 103 and output unit 104.

Processor 101, memory 102, input unit 103 and output unit 104 can be connected by BUS or other methods, and BUS connecting is showed in FIG. 10 for an example.

Memory 102 can be used for storing non-transitory software program, non-transitory computer executable program and modules as a non-transitory computer-readable storage medium, such as corresponding program instructions/modules for the methods for handshaking between a client and a server mentioned by embodiments of the present disclosure (such as shown in FIG. 5, first forwarding unit 51, second forwarding unit 52 and third forwarding unit 53). Processor 101 performs kinds of functions and handshaking between a client and a server of the electronic device by executing non-transitory software program, instructions and modules which are stored in memory 102, thereby realizes the methods for handshaking between a client and a server mentioned by embodiments of the present disclosure.

Memory 102 can include program storage area and data storage area, thereby the operating system and applications required by at least one function can be stored in program storage area and data created by using the device for handshaking between a client and a server can be stored in data storage area. Furthermore, memory 102 can include high speed Random-access memory (RAM) or non-volatile memory such as magnetic disk storage device, flash memory device or other non-volatile solid state storage devices. In some embodiments, memory 102 can include long-distance setup memories relative to processor 101, which can communicate with the device for handshaking between a client and a server by networks. The examples of said networks are including but not limited to Internet, Intranet, LAN, mobile Internet and their combinations.

Input unit 103 can be used to receive inputted number, character information and key signals causing user configures and function controls of the device for handshaking between a client and a server. Output unit 104 can include a display screen or a display device.

The said module or modules are stored in memory 102 and perform the methods for handshaking between a client and a server when executed by one or more processors 101.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The apparatus embodiment set forth above is merely exemplary, wherein units described as detached parts can be or not be detachable physically; parts displayed as units can be or not be physical units, i.e., either located at the same place, or distributed on a plurality of network units. Modules may be selected in part or in whole according to actual needs for achieving objectives of the solution of this embodiment.

It can be known from the foregoing implementation modes, those skilled in the art may clearly know that various implementation modes can be implemented by feat of software and necessary general hardware platform, or of course by means of hardware. Based on such an understanding, the foregoing technical solutions in essence or that part of contribution to the prior art may be embodied in the form of software products, which may be stored in computer-readable storage media, such as ROM/RAM, diskettes or optical disks and the like, including some instructions so that it is possible to execute embodiments or methods as recited in some parts of embodiments by a computer equipment (a personal computer, or a server, or network equipment, etc.).

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the spirit or scope of the technical solutions of the embodiments of the present disclosure.

What is claimed is:

1. A method for handshaking between a client and a server, implemented by a cache server, comprising:
forwarding handshaking request information sent by the client to a source server, wherein the handshaking request information is configured to request to establish a handshaking process with the source server;
forwarding, to the client, certificate information sent by the source server, wherein the certificate information is encrypted with a private key by the source server; and
after the client verifies the certificate information, forwarding, to the source server, key generation information sent by the client so that the source server obtains a symmetric key by decrypting the key generation information with the private key.

2. The method according to claim 1, wherein forwarding, to a source server, handshaking request information sent by the client comprises:
forwarding the handshaking request information to the source server according to a domain name in the handshaking request information.

3. The method according to claim 1, wherein forwarding, to the source server, key generation information sent by the client comprises:
forwarding a first random data generated by the client to the source server so that the source server generates the symmetric key according to the first random data and a second random data generated by the source server; and
the method further comprises:
forwarding the second random data generated by the source server to the client so that the client generates a symmetric key identical to the symmetric key generated by the source server according to the first random data and the second random data.

4. The method according to claim 1, wherein the certificate information comprises a second random data generated by the source server; and
forwarding, to the source server, key generation information sent by the client comprises:
forwarding the symmetric key generated by the client to the source server, wherein the symmetric key is the symmetric key generated by the client according to a first random data generated by the client and the received second random data.

5. An electronic device, comprising:
at least one processor; and
a memory communicably connected with the at least one processor for storing instructions executable by the at least one processor, wherein execution of the instructions by the at least one processor causes the at least one processor to:
forward handshaking request information sent by the client to a source server, wherein the handshaking request information is configured to request to establish a handshaking process with the source server;
forward, to the client, certificate information sent by the source server, wherein the certificate information is encrypted with a private key by the source server; and
after the client verifies the certificate information, forward, to the source server, key generation information sent by the client so that the source server obtains a symmetric key by decrypting the key generation information with the private key.

6. The electronic device according to claim 5, wherein forwarding, to a source server, handshaking request information sent by the client comprises:
forwarding the handshaking request information to the source server according to a domain name in the handshaking request information.

7. The electronic device according to claim 5, wherein forwarding, to the source server, key generation information sent by the client comprises:
forwarding a first random data generated by the client to the source server so that the source server generates the symmetric key according to the first random data and a second random data generated by the source server; and
wherein the instructions are executed to cause the at least one processor to:
forward the second random data generated by the source server to the client so that the client generates a symmetric key identical to the symmetric key generated by the source server according to the first random data and the second random data.

8. The electronic device according to claim 5, wherein the certificate information comprises a second random data generated by the source server; and
forwarding, to the source server, key generation information sent by the client comprises:
forwarding the symmetric key generated by the client to the source server, wherein the symmetric key is the symmetric key generated by the client according to a first random data generated by the client and the received second random data.

9. An electronic device, comprising:
at least one processor; and
a memory communicably connected with the at least one processor for storing instructions executable by the at least one processor, wherein execution of the instructions by the at least one processor causes the at least one processor to:
receive, through a cache server, handshaking request information sent by the client, wherein the handshaking request information is configured to request to establish a handshaking process with the electronic device;
encrypt certificate information with a private key managed by the electronic device;
send, to the cache server, the encrypted certificate information configured to be forwarded to the client so that the client verifies the certificate information;
receive key generation information sent by the client through the cache server; and
decrypt the key generation information with the private key and obtain a symmetric key.

10. The electronic device according to claim 9, wherein the key generation information is a first random data generated by the client;
the instructions are executed to cause the at least one processor to:
generate a symmetric key according to the first random data and a generated second random data; and
after obtaining a symmetric key, the instructions are executed to cause the at least one processor to:
send, to the cache server, the second random data configured to be forwarded to the client so that the client generates an identical symmetric key according to the first random data and the second random data.

11. The electronic device according to claim 9, wherein the certificate information comprises a second random data generated by the electronic device; and
receiving key generation information sent by the client through the cache server comprises:
receiving a symmetric key sent by the client through the cache server, wherein the symmetric key is generated by the client according to a first random data generated by the client and the second random data in the certificate information.
